(19) United States
(12) Patent Application Publication
(10) Pub. No.: US 2006/0017333 A1
(43) Pub. Date: Jan. 26, 2006

(54) Optical scanner

(76) Inventors: Nicolas G. Loebel, Redmond, WA (US); Andreas Rose, Sammamish, WA (US); Mark Gitlin, Bellevue, WA (US); David Melville, Issaquah, WA (US)

Correspondence Address: DOBRUSIN & THENNISCH PC, 29 W LAWRENCE ST, SUITE 210, PONTIAC, MI, 48342, US

(21) Appl. No.: 11/169,028

(22) Filed: Jun. 28, 2005

Related U.S. Application Data
(60) Provisional application No. 60/583,959, filed on Jun. 29, 2004.

(51) Int. Cl. H02K 33/00; G02B 26/08

(52) U.S. Cl. 310/36; 359/291; 359/223; 359/226

(57) ABSTRACT

An optical scanner comprising stators spaced apart from each other but ferromagnetically coupled together; a magnet positioned relative to the stators such that axis of symmetry of a magnetic field created by the magnet is substantially equidistant from and passes in between ends of the stators; and a flexure element positioned relative to the stators and the magnet such that its center point substantially intersects axis of symmetry of the magnet's magnetic field, wherein the flexure element is not in physical contact with either the stators or the magnet. A method for oscillating an optical scanner's flexure element comprising using a magnet disposed between two stators and beneath the flexure element to create two magnetic circuits that are generally symmetric and coplanar with one another, wherein a portion of the circuits share a common magnetic path through the magnet and remaining, non-common paths of the circuits through the stators are counter-directional relative to each other; applying electromagnetic flux to such circuits via stator electrical coils enhancing flux through one circuit while impeding flux through the other circuit and keeping the stator-induced flux vector through the magnet unchanged; and reversing polarity of the stator-induced electromagnetic flux at a regular frequency in order to oscillate the flexure element.

### CLAIM OF BENEFIT OF FILING DATE

The present application claims the benefit of the filing date of U.S. Provisional Application Ser. No. 60/583,959, filed on Jun. 29, 2004, and hereby incorporated in its entirety by reference.

### TECHNICAL FIELD

The present invention is directed to an optical scanner having both stationary magnets and stationary drive coils.

### BACKGROUND OF THE INVENTION

While optical resonant scanners are known, in general, they are not capable of sustained operation at frequencies significantly above 10 kHz, especially when large aperture mirrors, high scan angles and/or mirrors composed of thick material (to retain dynamic flatness) are involved. Most known resonant scanners that are magnetically driven include either moving magnets or moving coils as components of an electromagnetic circuit for generating and maintaining oscillatory motion of a flexure element. Many of these scanners have a high rotational inertia associated with the flexure element, because the electromagnetic drive components are physically coupled to the element in some way. High rotational inertia thereby makes it difficult to attain the high resonant frequencies sought for many technical applications.

There is another type of optical resonant scanner design that utilizes neither moving magnets nor moving coils for generating and maintaining the oscillatory motion. An example of this type of design is generally embodied in U.S. Pat. No. 5,557,444 (“the '444 design”).

The '444 design uses two permanent magnets to drive a mirror. These permanent magnets are in physical contact with a ferromagnetic flexure. The permanent magnet flux paths are directed from each of the two magnets through the length of the flexure, through ferromagnetic stators and back to the magnets via a ferromagnetic base. These long flux pathways provide substantial opportunities for eddy current generation and loss of drive efficiency via heating of the ferromagnetic material.

### SUMMARY OF THE INVENTION

The present invention overcomes several disadvantages of prior resonant optical scanners. The optical scanner of the present invention is capable of operating at or near a design frequency that can range from very low to very high frequencies (e.g., above 10 kHz). It provides better drive efficiency compared to prior resonant optical scanners without generating excess heat. It can move relatively large aperture reflecting mirrors or other payloads across large scan angles. It can also move mirrors manufactured from thick material in order to retain their dynamic flatness. A scanner made in accordance with the invention may have numerous diverse uses such as projection displays, printing, optical target acquisition and ranging, area illumination, raster image data acquisition, bar code readers, and other medical, military, and consumer applications. The advantages and features of the invention are described below.

The present invention provides an optical scanner comprising: first and second stators spaced apart from each other and ferromagnetically coupled together; a magnet positioned relative to the stators such that axis of symmetry of a magnetic field created by the magnet is substantially equidistant from and passes in between the stators; and a flexure element positioned relative to the stators and the magnet such that center point of the flexure element substantially intersects axis of symmetry of the magnet's magnetic field, wherein the flexure element is not in physical contact with either the stators or the magnet.

The present invention further provides an optical scanner comprising: a ferromagnetic base with a first stator post and a second stator post formed thereon, the first and second stator posts being generally parallel to each other; a first electrical coil wound about the first stator post in a first direction; a second electrical coil wound about the second stator post in a second direction opposite the first direction; a magnet disposed on the ferromagnetic base and in-between and equidistant from the stator posts; a flexure having first and second support portions mounted respectively on first and second support bases and having a centrally located portion disposed above the stator posts and the magnet, with centroid of the central portion located directly above the magnet and an axis of rotation equidistant to the stator posts; the first and second support bases being comprised of non-ferromagnetic material and being located symmetrically outside the ferromagnetic base and attached to the ferromagnetic base, so as to provide an integrally supporting structure for the scanner; a flexure element mounted on or created directly from the centrally located portion of the flexure, the flexure element being oscillated about the axis of rotation when an alternating drive signal is coupled to the first and second electrical coils.

The present invention also provides a method for oscillating a flexure element of an optical scanner comprising: using a magnet disposed between two stators and beneath the flexure element to create a first and second magnetic circuits that are generally symmetric and coplanar to one another, wherein a portion of the circuits share a common magnetic path through the magnet and remaining, non-common paths of the circuits through the stators are counter-directional relative to each other; applying electromagnetic flux to one or both of the circuits via stator electrical coils thereby enhancing flux through the first circuit while impeding flux through the second circuit and keeping the stator-induced flux vector through the magnet unchanged; and reversing polarity of said the stator-induced electromagnetic flux at a regular frequency in order to oscillate the flexure element.

These and other objects, advantages, and novel features of the present invention, as well as details of an illustrated embodiment thereof, will be more fully understood from the following description and from the drawings.

### BRIEF DESCRIPTION OF THE DRAWINGS

FIG. 1 is a perspective view of a first embodiment of an optical resonant scanner in accordance with the present invention;

FIG. 2 is an exploded perspective view of the optical scanner of FIG. 1 shown without flexure mounts for clarity;

FIG. 3 is an exploded perspective view of the electromagnetic drive components of the optical scanner of FIG. 1; and

FIG. 4 is an end view of the electromagnetic drive components of the optical scanner of FIG. 1 showing the direction of the lines of static (DC) magnetic flux derived from a centrally located magnet.

### DESCRIPTION OF THE PREFERRED EMBODIMENT

The Scanner

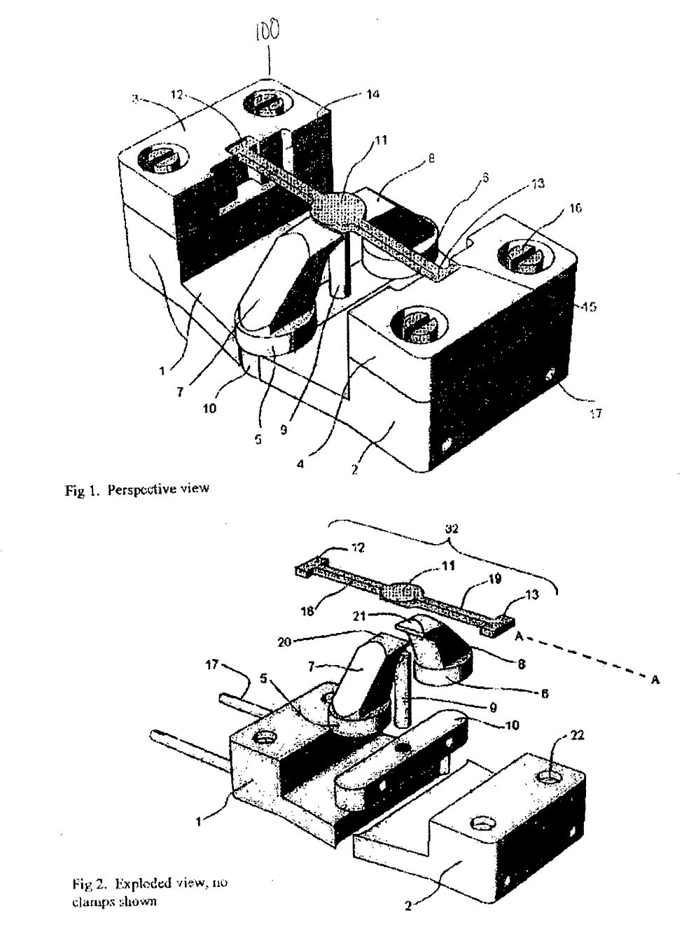

The resonant optical scanner of the present invention 100 is illustrated in FIGS. 1-4. Referring to FIGS. 1-2, the scanner includes base plates 1, 2 which are connected together via art-disclosed means (e.g., the bolts 17 shown in FIG. 2) to provide mechanical supports for the scanner 100. Mounted on opposite ends of the base plates 1, 2 are end mounts 3, 4. The end mounts are also connected to the base plates 1, 2 via art-disclosed means (e.g., screws 16 and recesses 22 shown in FIGS. 1-2). Alternatively, the base plates 1, 2 and the end mounts 3, 4 can be integrally formed in one piece or two pieces of materials (i.e., base plate 1 and end mount 3 forming a single piece while base plate 2 and end mount 4 forming another piece).

Referring to FIG. 2, the scanner 100 includes a flexure 32 that is connected to the end mounts 3, 4. The flexure includes a flexure element 11 that is magnetic and serves as the rotating or oscillating element of the scanner 100. The flexure element 11 includes a light reflecting, light emitting, or light detecting element. Such element may be created using any suitable art-disclosed methods. For example, it may be created by polishing; or placement of an evaporated film of metal, a multi-layer thin film reflector, a diffraction grating, mirror or reflective surface, one or more light emitting elements, and/or one or more light detecting elements. It is preferred that the flexure element 11 is located at or near the central portion of the flexure 32. It is also preferred that the central portion of the flexure 32 containing the flexure element 11 protrudes laterally outwardly relative to the lengthwise axis of the flexure 32 to create a generally elliptical or circular shape in plan-form.

Referring to FIG. 1, a preferred embodiment of the flexure 32 has a central portion that extends outward via two members 18, 19 along the axis of rotation. It is preferred that the members 18, 19 are generally thin and rectangular in shape. The end of each of these members 18, 19 terminates in a mounting tab (12, 13). The mounting tabs 12, 13 are attached to the end mounts 3, 4 via suitable art-disclosed means. For example, the mounting tabs 12, 13 can be captured by reveals 14, 15 located within the end mounts 3, 4 providing supports (not shown) that clamp to the mounting tabs 12, 13 or they 12, 13 can be welded or screwed onto the end mounts 3, 4. It is preferred that the attachment means are of a design such that flexure 32 is rigidly attached to the end mounts 3, 4 without applying constraining force to any component of the flexure 32 that is in rotational motion (e.g., the flexure element 11).

Referring to FIGS. 1-4, disposed beneath the flexure element 11 and spaced from the under side of the flexure 32 by an air gap is a magnet 9. This magnet can be any art-disclosed magnet such as a permanent magnet, an electromagnet, or the like. It is preferred that the magnet 9 is disposed directly beneath the flexure element 11 with one end 25 of the magnet 9 facing the underside of the flexure 32 as shown in FIG. 4. It is also preferred that the air gap between the flexure 32 and the magnet 9 is relatively small so as to allow the magnetic flux from the magnet 9 to couple efficiently through the air gap to the flexure 32. The magnet 9 can be of any suitable art-disclosed shape. It is preferred that the magnet 9 be generally cylindrical.

Disposed on opposite sides of the magnet 9 are first and second stator posts 7, 8. Stator electrical coils 5, 6 are wound or polarized in opposite directions about their respective stator posts 7, 8 forming two stators 38, 40 that are spaced apart from each other. The magnet 9 is positioned relative to the stators 38, 40 such that axis of symmetry of a magnetic field created by the magnet 9 is substantially equidistant from and passes in between ends of the stators 38, 40 (i.e., tips 20, 21 of the stators posts 7, 8). The stator posts 7, 8 are located generally orthogonal to the long or lengthwise axis of the flexure 32 and generally equidistant from both the magnet 9 and the flexure 32. The stator posts 7, 8 terminate just short of edges 26, 27 of the flexure 32 at the location of the flexure element 11, so that there are air gaps between the tips 20, 21 of the stator posts 7, 8 and the flexure 32. It is preferred that the tips 20, 21 are beveled or shaped to define an extended overlap between themselves and the edges 26, 27 of the flexure 32. Equal and opposite perturbations of the magnetic fields flowing across the respective air gaps are used to exert a torsional force on the flexure element 11 in order to rotate it about the lengthwise axis of the flexure 32. The flexure element 11 is positioned relative to the stators 38, 40 and magnet 9 such that its center point substantially intersects axis of symmetry of the magnet's 9 magnetic field and yet the flexure element 11 is not in physical contact with either the stators 38, 40 or the magnet 9.

Disposed between the base plates 1, 2 and preferably clamped or sandwiched between them, is a flux return bar 10. The stator posts 7, 8 are mounted on the flux return bar 10 forming a magnetic circuit between the stators 38, 40. This design allows the stators 38, 40 to be spaced apart from each other but ferromagnetically coupled together as shown in FIG. 4. FIGS. 1-4 show the flux return bar 10 and the stator posts 7, 8 as individual pieces. In an alternative embodiment of the present invention, the flux return bar 10 and the stator posts 7, 8 are integrally formed in one piece of material.

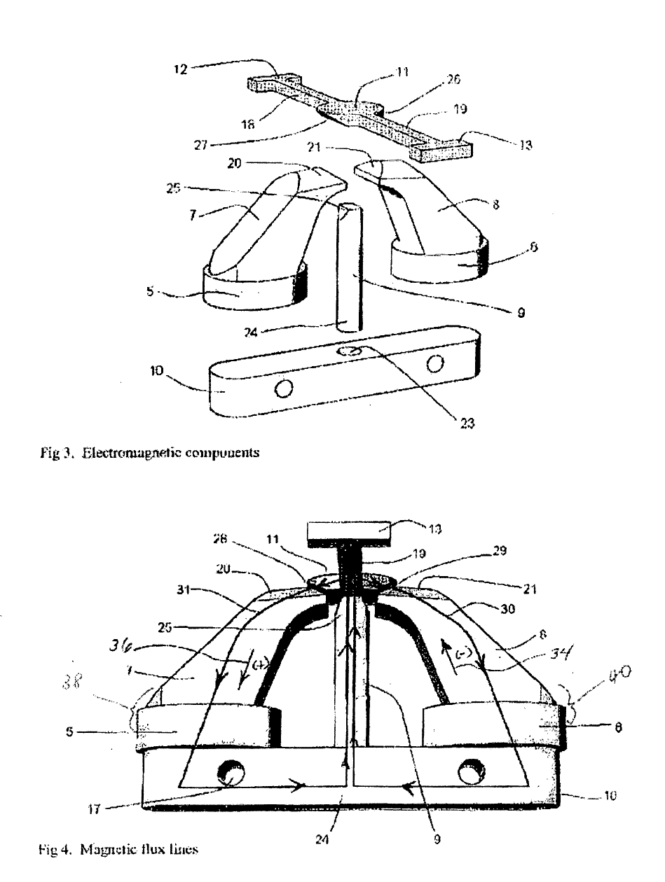

The magnet 9 is attached to the flux return bar 10 via art-disclosed means. For example and referring to FIG. 3, a recess or cavity 23 is formed in the flux return bar 10 for the attachment of the magnet 9. Alternatively, the magnet 9 and the flux return bar 10 are integrally formed in one piece of material. If desired, this integrally formed piece may also include the stator posts 7, 8.

The scanner 100 may optionally include suitable art-disclosed detection means (not shown) to detect oscillation of the flexure element 11. For example, the detection means can be an optical system whereby a light beam is caused to intersect with underside of the flexure 32, the light beam reflecting off the flexure 32 and impinging upon an optical detector capable of detecting modulation of the light beam proportional to angle of rotation of the flexure element 11.

The flexure element 11, the stator posts 7, 8, the magnet 9, and the flux return bar 10 are preferably constructed of ferromagnetic material(s). It is also preferred that the flexure 32 including the flexure element 11, the members 18, 19 and the mounting tabs 12, 13 are constructed of a single piece of ferromagnetic material. However, the present invention does not require all of the elements of the flexure 32 to be constructed of ferromagnetic material(s) and/or be magnetic. In fact, only the flexure element 11 or the central portion of flexure 32 beneath the flexure element 11 needs to be composed of ferromagnetic material.

Any suitable art disclosed ferromagnetic material can be used for the construction of the above-discussed components and/or elements of the scanner 100. Nevertheless, it is preferred that the ferromagnetic material is selected from the group consisted of stainless steel, nickel, cobalt, iron and a combination thereof. It is more preferred that the ferromagnetic material is spring steel. For example, in a preferred embodiment, the flexure 32 is constructed of spring steel and is a torsional type of spring having a spring constant determined by its length, width and thickness while the stator posts 7, 8 and the flux return bar 10 are composed of soft iron or sintered ferrite powders, laminated ferromagnetic material (e.g., multiple thin laminations of ferromagnetic material interposed with insulative material), or the like.

When using llamellar arrays of ferromagnetic material, the lamellar thickness is preferably in the range of about 0.001 inch to about 0.006 inch thickness per lamella with a total stack thickness of about 0.1 inch to about 1 inch. It is also preferred that the individual lamellae are separated from one another via extremely thin layers of suitable art-disclosed insulating material (e.g., varnish or the like). Lamellar array of ferromagnetic material minimizes formation of eddy currents and provides high saturation flux density.

The remaining components of the scanner 100 can be constructed of non-ferromagnetic material(s) as they are not required to sustain or carry any significant electromagnetic flux or eddy currents. The base plates 1, 2 and the end mounts 3, 4 may be composed of any suitable art-disclosed material capable of rigidly supporting the flexure 32.

Operation of the Scanner

As explained in details below, the present invention provides a method for oscillating a flexure element of a resonant optical scanner comprising: using a magnet disposed between two stators and beneath the flexure element to create a first and second magnetic circuits that are generally symmetric and coplanar with one another, wherein a portion of the circuits share a common magnetic path through the magnet and remaining, non-common paths of the circuits through the stators are counter-directional relative to each other; applying electromagnetic flux to one or both of the circuits via stator electrical coils thereby enhancing flux through the first circuit while impeding flux through the second circuit and keeping the stator-induced flux vector through the magnet unchanged; and reversing polarity of the stator-induced electromagnetic flux at a regular frequency in order to oscillate the flexure element.

In the absence of drive signal(s) to the stator electrical coils 5, 6, a magnetic flux is generated by the magnet 9 in a direction defined by the body of the magnet 9. If the magnet 9 is a permanent magnet, then the flux generated is constant. If the magnet 9 is an electromagnet, then the static (DC) flux flowing through first and second magnetic circuits may be altered at will, and therefore the extent of scan angle altered without altering the stator coil drives 5, 6. Assuming the polarity of the magnet 9 is aligned so that positive (+) is upward, then the magnetic flux generated by the magnet 9 travels vertically upward across the air gap located beneath the flexure 32 and enters the flexure element 11. Referring to FIG. 4, the flux splits into the two generally symmetric, coplanar, permanent magnetic circuits 30, 31 and each circuit (30 or 31) is drawn in opposite lateral directions relative to the lengthwise axis of the flexure 32. With the exception of the common flux path defined by the magnet 9 and, to a certain extent, small portions of the scanner structure immediately above and below the magnet 9, the permanent magnet flux direction through circuits 30, 31 is counter-directional or counter-rotational. Circuit 30 extends from the top pole 25 of the magnet 9 to the approximate centroid of the flexure element 11, sideways through to edge 29 of the flexure element 11, across the air gap, through stator post 8, and then through the alternate half of the flux return bar 10 and back to the bottom pole 24 of the magnet 9. Circuit 31 extends from the top pole 25 of the magnet 9 to the approximate centroid of the flexure element 11, then sideways through to edge 28 of the flexure element 11, across the air gap, through stator post 7, and then through one half of the flux return bar 10 and back to bottom pole 24 of the magnet 9. Accordingly, circuits 30 and 31 converge together at the bottom of the magnet 9 via the flux return bar 10.

The above flux arrangement creates a net attractive force between the top pole 25 of the magnet 9 and the flexure element 11, which tends to normally stabilize the flexure 32 in the horizontal position. It also creates the two symmetrical magnetic circuits 30, 31, which are normally balanced, but can be unbalanced when drive signal(s) are applied to the coils 5, 6.

When a periodic drive signal, such as a square wave, is applied to the coils 5, 6, alternating magnetic fields are created which cause the flexure element 11 to oscillate back and forth about the axis of rotation A-A. The coils 5, 6 are generally symmetrically wound and symmetrically driven. However, their polarity is operatively reversed relative to each other, so that the electromagnetic influence that each one applies to its respective magnetic circuit is different. More particularly, coil 6 will create an electromagnetic flux that impedes or cancels out some of the magnet-induced flux in circuit 30, as shown by the small arrow 34 in FIG. 4. Conversely, coil 5 applies an equal but opposite electromagnetic flux that adds to the magnet-induced flux in circuit 31, as shown by the small arrow 36, as the square wave reaches maximum positive amplitude. When the square wave moves towards maximum positive amplitude, the magnetic field established within stator post 7 is concentrated at the tip 20 and flows across the intervening air gap into edge 28 of the flexure element. This field tends to reinforce the existing static magnetic flux at the edge 28 generated by the magnet 9. The reinforced flux density increases the existing attractive force between the edge 28 and the tip 20. At the same time, the coil 6 establishes a field of opposite polarity in the stator post 8 that reduces the attractive force between the tip 21 and edge 29 of the flexure element 11. The resulting unbalancing of magnetic forces between the flexure element 11 and the tips 20, 21 produces a moment about the centerline A-A and the flexure element 11 will rotate in the direction of the torque vector about A-A. When the square wave transitions from maximum positive towards maximum negative amplitude, the electromagnetic fields established by the coils 5, 6 and the stator posts 7, 8 reverse polarity (i.e., the directions of arrows 34, 36 reverse), thereby creating a torque of opposite sign on the flexure element 11. Rotation of the flexure element 11 therefore occurs about A-A in the opposite direction to the previous case. The frequency of rotation is related to the frequency of the square wave applied to coils 5, 6.

As mentioned above, the magnetic circuits associated with the stators 38, 40 share a common path through the magnet 9. Since the contributions from the stators 38, 40 to the static magnet flux derived from the magnet 9 at the flexure element 11 are of equal magnitude and opposite sign, the net flux contributions from the stators 38, 40 cancel each other within the magnet 9. No significant eddy currents therefore flow in the magnet 9 as there is effectively no alternating component of magnetic flux within the magnet 9. It is noted that for high frequencies of operation, the number of turns of wire in each of the coils 5, 6 should be decreased as the electrical impedance of such coils 5, 6 also increases with operating frequency.

Eddy current losses are inversely proportional to the volume resisitivity of the materials used to form the circuits 30, 31. Therefore, by lowering the volume resistivity of the stator posts 7, 8, the flexure element 11 and the flux bar 10, the eddy current losses at high frequencies of operation can be reduced. The volume resistivity can be lowered, for example, by utilizing laminations or sintered powders of ferromagnetic material in forming components 7, 8, 10 and/or 11.

In all portions of the magnetic circuits through the stator posts 7, 8, except the common path through the magnet 9, the strength of the magnetic flux is increased or decreased proportionally in magnitude and direction to the electromagnetic fluxes generated by the coils 5, 6. However, the flux established by and flowing through the magnet 9 never changes, because the flux contributions from the stator posts 7, 8 are equal in magnitude, and opposite in sign, and therefore cancel one another within the magnet 9. The intrinsic coercive force of the magnet 9 is therefore never challenged, and the operating point of the magnet 9 on its' demagnetization curve is fixed. This is true whether the magnet 9 is a permanent magnet or an electromagnet with adjustable intrinsic magnetic field strength.

The present invention provides an optimum drive principle for a magnet-based torque generator and distinguishes it from prior art. For example, in the '444 design, two permanent magnets are used to drive the flexure element, both of which are in physical contact with either end of the flexure. The permanent magnet flux paths are directed from each of the two magnets through the length of the flexure, through the stators, and back to the respective magnets via the ferromagnetic base of the scanner. These long flux pathways provide substantial opportunities for eddy current generation, and therefore loss of drive efficiency via heating of the ferromagnetic material. As electrical energy flows through the stator coils disclosed in the '444 design, the magnetic flux generated by the counter-wound coils must oppose or enhance the flux created by the permanent magnets, either demagnetizing or remagnetizing the magnets. While this does result in net torque placed on the flexure, the magnetic operating point is repetitively moved at the scanner frequency, creating heat, loss of drive efficiency and potentially irreversible loss of magnetic coercivity.

In the present invention and unlike the '444 design, the scanner 100 has static (DC) magnetic flux traveling transversely to the long axis of the flexure 32 across a very short distance located approximately between the centroid of each stator post (7 or 8) and the flexure element 11 (preferably located at the centroid of the flexure 32). Also unlike the '444 design, the only element of the flexure 32 that carries magnetic flux is the flexure element 11, while the base plates 1, 2 are not required to be composed of ferromagnetic material. The short flux-carrying paths, and the in-plane nature of those paths tend to minimize the generation of eddy currents and magnetic flux shorting paths, both of which otherwise tend to limit drive efficiency via heating of the ferromagnetic material and reduction in magnetically-applied torsional force to the flexure element 11.

In the present invention, torque is generated on the flexure 32 with a force that is proportional to the electrical power delivered to the stator coils 5, 6. Oscillating stator coil power produces an oscillatory motion. When the frequency of power oscillation is matched to the natural frequency of the flexure 32, then relatively large angular oscillations can be produced at relatively low levels of drive power. The nature of the flexural oscillation can be complex, because a flexure having the plan-form described above may oscillate in more than one mode. Harmonics to the fundamental mode, as well as higher-order modes, may also exist. Nevertheless, appropriate numerical methods can be used to design the flexure such that one or another harmonic mode, or a combination of modes, can be favored. In the case of a line scanner, the first-order torsional mode is desired, and it is possible to design the flexure in such a way as to bring the first-order torsional mode amplitude to a least one order of magnitude above all other modes.

While it may be possible to design a resonant flexure using the above drive method so that it has a desired fundamental frequency for one or more desired modes, it may not be possible to electromagnetically drive the flexure at precisely that frequency. This is related to the fact that part of the drive power is lost as heat, principally through the development of eddy currents within the flux-bearing ferromagnetic components of the device. The rate of eddy-current generation is proportional to the square of the drive frequency, and for standard ferritic materials, the proportion of drive power lost to eddy current heating begins to rise steeply in the region of 10-15 kHz while the power direct to useful work asymptotes to some limit.

Moreover, even if the resonant flexure can be driven at the design frequency, it may not be possible to derive sufficient amplitude at that frequency, if the magnetic flux density within the ferritic materials approaches a saturation limit (approximately 18 kGauss for standard steels). At that point, all elementary magnetic moments become oriented in one direction, and an increase in current to the drive coils produces little or no increase in induction, and therefore, little or no increase in oscillatory drive.

Finally, even if the resonant design flexure can be driven at appropriate frequency, with an appropriate oscillation amplitude, it may not exhibit sufficient lifetime (or mean time to failure) while operating under those parameters. This is related to the fatigue limit of the ferromagnetic material(s) chosen for use. Most ferromagnetic materials are crystalline in nature, and repetitive deformation, even within their elastic limit, may result in microcrack formation and propagation that causes catastrophic failure.

To address the above-discussed issues, the scanner 100 includes means for minimizing the generation of eddy currents, by utilizing lamellar arrays of ferromagnetic material rather than solid ferritic (ferrites) or crystalline materials (steels) in the construction of the variable-flux bearing pathways. The lamellar nature of the ferromagnetic material minimizes formation of eddy currents by interrupting the electrically continuous length on a small length scale.

In addition, the scanner 100 includes means for minimizing the onset of magnetic saturation for maximizing the available drive power envelope. Individual lamellae used to make the variable-flux paths are constructed from a ferromagnetic material having very high permeability and therefore high saturation flux density.

Finally, the scanner 100 is structurally designed to minimize undesirable flux leakage paths associated with edge effects. In particular, the stator tips 20, 21 are very carefully designed to maximize flux transmission through the air gaps and the flexure element 11, rather than directly between the tips 20, 21 and the upper pole 25 of the magnet 9, or any other part of the structure. The single magnet 9 and both stator posts 7, 8 are disposed close to one another, and substantially in a single plane transverse to the long axis of the flexure 32, providing for very short flux pathways and minimum opportunity for flux leakage and eddy current generation.

In accordance with the design improvements set forth above, we believe that a scanner made in accordance with the present invention will exhibit very high performance. For example, the scanner with a 5-mm mirror diameter may be able to scan a light beam through more than 22 degrees (optical scan angle) at 16 kHz while utilizing less that 10 W of drive power. The design may scale to 24 kHz and beyond without substantially changing the design parameters discussed above.

What is claimed is:

1. An optical scanner comprising:
first and second stators spaced apart from each other and ferromagnetically coupled together;
a magnet positioned relative to said stators such that axis of symmetry of a magnetic field created by said magnet is substantially equidistant from and passes in between said stators; and
a flexural element positioned relative to said stators and said magnet such that center point of said flexural element substantially intersects axis of symmetry of said magnet's magnetic field, wherein said flexure element is not in physical contact with either said stators or said magnet.

2. The scanner of claim 1 wherein said flexure element contains an element selected from a group consisting of a polished surface, an evaporated film of metal, a multi-layer thin film reflector, a diffraction grating, a mirror, one or more light emitting elements, one or more light detecting elements, and a combination thereof.

3. The scanner of claim 1 wherein said element contained in said flexure element is integrally formed within said flexure.

4. The scanner of claim 1 wherein said scanner is capable of operating at a frequency above 10 kHz.

5. The scanner of claim 1 wherein
said first stator comprises a first stator post and a first stator electrical coil;
said second stator comprises a second stator post and a second stator electrical coil; and
said stators are ferromagnetically coupled together via a flux return bar that is connected to said stators and said magnet.

6. The scanner of claim 5 wherein said flexure element, said stator posts, and said flux return bar are constructed of a ferromagnetic material.

7. The scanner of claim 6 wherein said ferromagnetic material is selected from a group consisting of stainless steel, spring steel, nickel cobalt, iron and a combination thereof.

8. The scanner of claim 5 wherein said stator posts and said flex return bar is constructed of a ferromagnetic material selected from the group consisting of lamellar arrays of ferromagnetic material, sintered ferritic powders, and a combination thereof.

9. The scanner of claim 5 further comprising:
first and second support bases attached to said flex return bar;
a flexure having a first member attached to said first support base and a second member attached to said second support base;
wherein about central portion of said flexure contains said flexure element and said flexure element oscillates about an axis of rotation equidistant to said stators when an alternating drive signal is coupled to said stator electrical coils.

10. The scanner of claim 9 wherein said oscillation of said flexure element is detected by detection means.

11. The scanner of claim 10 wherein said detection means is comprised of an optical system whereby a light beam is caused to intersect with underside of said flexure, said light beam reflecting off said underside and impinging upon an optical detector capable of detecting modulation of said light beam proportional to angle of rotation of said flexure element.

12. An optical scanner comprising:
a ferromagnetic base with a first stator post and a second stator post formed thereon, said first and second stator posts being generally parallel to each other,
a first electrical coil wound about said first stator post in a first direction;
a second electrical coil wound about said second stator post in a second direction opposite said first direction;
a magnet disposed on said ferromagnetic base and in-between and equidistant from said stator posts;
a flexure having first and second support portions mounted respectively on first and second support bases and having a centrally located portion disposed above said stator posts and said magnet, with centroid of said central portion located directly above said magnet and an axis of rotation equidistant to said stator posts;
said first and second support bases being comprised of non-ferromagnetic material and being located symmetrically outside said ferromagnetic base and attached to said ferromagnetic base, so as to provide an integrally supporting structure for said scanner;
a flexure element mounted on or created directly from said centrally located portion of said flexure, said flexure element being oscillated about said axis of rotation when an alternating drive signal is coupled to said first and second electrical coils.

13. The scanner of claim 12 wherein an air gap exists between said magnet and said flexure element.

14. The scanner of claim 12 wherein an air gap exists between said flexure element and said first stator post and an air gap exists between said flexure element and said second stator post.

15. The scanner of claim 12 wherein said flexure element, said stator posts are constructed of a ferromagnetic material.

16. The scanner of claim 15 wherein said ferromagnetic material is selected from a group consisting of stainless steel, spring steel, nickel cobalt, iron and a combination thereof.

17. The scanner of claim 12 wherein said flexure element contains an element selected from a group consisting of a polished surface, an evaporated film of metal, a multi-layer thin film reflector, a diffraction grating, a mirror, one or more light emitting elements, one or more light detecting elements, and a combination thereof.

18. The scanner of claim 12 wherein said oscillation of said flexure element is detected by detection means.

19. The scanner of claim 18 wherein said detection means is comprised of an optical system whereby a light beam is caused to intersect with underside of said flexure, said light beam reflecting off said underside and impinging upon an optical detector capable of detecting modulation of said light beam proportional to angle of rotation of said flexure element.

20. A method for oscillating a flexure element of a scanner, comprising:
using a magnet disposed between two stators and beneath the flexure element to create a first and second magnetic circuits that are generally symmetric and coplanar with one another, wherein a portion of said circuits share a common magnetic path through said magnet and remaining, non-common paths of said circuits through said stators are counter-directional relative to each other;
applying electromagnetic flux to one or both of said circuits via electrical coils enhancing flux through said first circuit while impeding flux through said second circuit and keeping stator-induced flux vector through said magnet unchanged; and
reversing polarity of said stator-induced electromagnetic flux at a regular frequency in order to oscillate said flexure element.
